(19) United States
(12) Patent Application Publication
(10) Pub. No.: US 2012/0096499 A1
(43) Pub. Date: Apr. 19, 2012

(54) APPARATUS AND METHOD FOR FACILITATING VIDEO-ON-DEMAND CATALOG SEARCH AND CONTENT DISTRIBUTION

(76) Inventors: Charles Dasher, Lawrenceville, GA (US); Chris Phillips, Hartwell, GA (US)

(21) Appl. No.: 13/008,604

(22) Filed: Jan. 18, 2011

Related U.S. Application Data
(60) Provisional application No. 61/394,483, filed on Oct. 19, 2010.

(51) Int. Cl. H04N 7/173; G06F 17/00

(52) U.S. Cl. 725/87; 235/375

(57) ABSTRACT

A system and method of video-on-demand (VOD) content search and distribution via an Internet Protocol (IP) network. A user sends a scan of a bar-coded identifier placed on a packaging or advertising material for a movie or other audio-visual program. Using the received barcode scan, the cable operator's VOD system checks the availability of the requested title under the VOD service. If the title is available, the system allows the user to instantaneously purchase and/or bookmark the title via a mobile device. If the title is currently unavailable “on demand”, the VOD system may send a notification to the user when the title becomes available. The bar code scan-based methodology enables the user to request desired titles even when the user is unaware of the titles available in a cable operator's VOD catalog. The IP network-based communication affords users substantially universal and instantaneous access to the desired VOD content with increased mobility and flexibility.

### CROSS-REFERENCE TO RELATED APPLICATIONS

This application claims the priority benefit under 35 U.S.C. §119(e) of U.S. Provisional Application No. 61/394,483 filed Oct. 19, 2010, the disclosure of which is incorporated herein by reference in its entirety.

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND

The present invention relates to video content delivery systems. More particularly, and not by way of limitation, the present invention is directed to a system and method for facilitating video-on-demand (VOD) catalog search and content distribution based on user scans of bar-coded identifiers associated with such VOD content.

Traditionally, television viewers consume content according to a schedule. For example, a television broadcaster would schedule a television show, event, or movie for broadcast at a certain time. In order to watch the broadcast, television viewers needed to tune into the broadcast on their television sets at the scheduled time. Over time, time-shifting technologies such as video cassette recorders (VCRs) and personal video recorders (PVRs) enabled television viewers to record content during the broadcast and then watch the content at a later time.

In recent years, in order to add additional value to their services, cable operators introduced video-on-demand (VOD) technology that enables cable subscribers to watch movies, television shows, and/or events “on demand” by requesting the content through, for example, a set-top box that is authorized to access the cable operator's equipment. Then, in response to the request from the cable subscriber, the cable operator transmits the requested content to the cable subscriber's set-top box, which enables the cable subscriber to watch the content on a television or video terminal connected to the set-top box.

### SUMMARY

Although the VOD option is available to cable subscribers as mentioned above, when a cable subscriber is interested in accessing the VOD system on their set-top box, the cable subscriber has a few limited and tedious methods of determining the currently-offered content on the VOD system or searching for the desired VOD content from huge selection of available VOD titles. One method involves accessing the VOD menu on the set-top box by manually (and sequentially) going through each entry on the television screen. Another method involves first searching the cable provider's web site for the VOD menu from an Internet-connected device such as a desktop computer, laptop computer, tablet computer, and the like, and then ordering the desired VOD content and watching it on the subscriber's television. Yet another method involves accessing the cable provider's web page using a mobile device such as a cellular phone, smartphone, and the like or using a dedicated application on the mobile device. In any event, each one of these methods involves extensive time-consuming user inputs (for example, typing or texting in the case of a mobile device, or searching and exploring a cable operator's website using a computer) and tedious clicks using a remote control (for example, in the case of searching the VOD menu displayed on a television screen).

It is therefore desirable to devise a system and method to facilitate VOD catalog search and content distribution in a user-friendly manner, which does not require extensive user inputs or tedious remote control-based clicks.

The present invention offers a solution to the time-consuming nature of current VOD content selection and delivery methods. According to an embodiment of the present invention, a user scans (using a device equipped with an input mechanism (for example, a barcode reader, camera)) a bar-coded identifier such as, for example, a universal product code (UPC) placed on a movie package (for example, a DVD or Blu-ray disc cover) or a QR (Quick Response) barcode that is placed in a movie preview, movie ticket, or some other type of advertising collateral for a movie or other audio-visual program of interest. When the user scans the identifier, the software on the user's device recognizes the identifier, and queries the VOD system as to the availability of the requested movie/program title. If the title is an offering within the VOD system, the VOD system allows the user to substantially instantaneously purchase and/or bookmark the movie/program title via users mobile device. In the case where the title is not available on the VOD system, the VOD system can send a notification (for example, via Short Messaging Service (SMS) to a user's cell phone, an email, etc.) to the user when the title is available for access on the VOD system. In view of ever-growing popularity of Internet-based devices and systems, the user queries and system responses/notifications are facilitated through the Internet, thereby offering the users significant mobility and ease of access to desired VOD content.

In one embodiment, the present invention is directed to a method of offering VOD content. The method comprises receiving an electronic representation of a bar-coded identifier associated with the VOD content using a processor. The method also comprises, using the processor, searching a database using the electronic representation to determine availability of the VOD content for immediate delivery, and providing a sender of the electronic representation with an option to substantially instantaneously access the VOD content when the VOD content is determined to be available for immediate delivery.

In another embodiment, the present invention is directed to a method of offering VOD content to a cable subscriber, wherein the VOD content is offered by a cable provider. The method comprises: the cable provider allowing the cable subscriber to send an electronic representation of a bar-coded identifier associated with the VOD content to a processor; the cable provider configuring the processor to use the electronic representation received thereby to determine availability of the VOD content for immediate delivery; and, using the processor, the cable provider providing the cable subscriber with an option to substantially instantaneously watch the VOD content when the VOD content is determined to be available for immediate delivery.

In another embodiment, the present invention is directed to a system for offering requested VOD content. The system comprises a database; a VOD catalog server, and a processor coupled to the database and the VOD catalog server. The database has stored therein a plurality of data entries along with a corresponding plurality of bar code identifications, wherein each data entry is associated with a corresponding VOD content. The VOD catalog server has stored therein information as to availability of the requested VOD content for immediate delivery. The processor is configured to: receive, via an Internet Protocol (IP) network, an electronic representation of a bar-coded identifier associated with the requested VOD content; search the first database using the electronic representation to identify therein a data entry associated with the requested VOD content; access the VOD catalog server using the identified data entry to determine availability of the requested VOD content for immediate delivery; and provide, via the IP network, an option to a sender of the electronic representation to substantially instantaneously access the requested VOD content when the requested VOD content is determined to be available for immediate delivery.

In view of the bar code scan-based search and retrieval of VOD content, the present invention provides a significantly effortless means to request desired VOD titles—even when a user is unaware of the titles available in a cable service providers VOD catalog. Furthermore, the IP network-based communication affords users substantially universal and instantaneous access to the desired VOD content without restricting the user's viewing option to a fixed television set. Because of availability of VOD content at many more devices than just a television set, user mobility is greatly enhanced without sacrificing the user's ability to order and view the desired VOD content.

### BRIEF DESCRIPTION OF THE DRAWINGS

In the following section, the invention will be described with reference to exemplary embodiments illustrated in the figures, in which:

FIG. 1 is a simplified block diagram of an exemplary embodiment of a VOD distribution system of the present invention;

FIG. 2 is a flow chart of a first exemplary embodiment of the VOD content distribution method of the present invention;

FIG. 3 shows exemplary details of the VOD distribution system illustrated in FIG. 1 according to one embodiment of the present invention; and

FIG. 4 is a flow chart of a second exemplary embodiment of the VOD content distribution method of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. Additionally, it should be understood that although the invention is described primarily in the context of a cable provider network, the invention can be implemented by other types of content providers as well (for example, satellite and broadcast television providers, subscription-based video rental services, and the like) as described in more detail below.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) in various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form.

It is noted at the outset that the terms “coupled,” “connected”, “connecting,” “electrically connected,” etc., are used interchangeably herein to generally refer to the condition of being electrically connected. Similarly, a first entity is considered to be in “communication” with a second entity (or entities) when the first entity electrically sends and/or receives (whether through wireline or wireless means) information signals (which may or may not contain audio-visual VOD content) to the second entity regardless of the type (analog or digital) of those signals. It is further noted that various figures (including component diagrams) shown and discussed herein are for illustrative purpose only, and are not drawn to scale.

It is observed at the outset that the term “video-on-demand” (VOD) is usually applied in the context of “on demand” delivery of audio-visual content (such as, for example, movies, television shows, and/or other programs) by a cable television network operator (or cable TV service provider) to a cable television subscriber. However, depending on the context, the term “VOD” according to the teachings of the present invention may include “on demand” delivery of audio-visual content by non-cable service providers as well, regardless of whether such service requires subscription or not. For example, it can be seen from the discussion below that the teachings of the present invention may be suitably applied to online DVD movie rental/download services that may offer streaming video/movie rentals on subscription-basis (for example, unlimited video downloads for a fixed monthly fee, or a fixed number of movie downloads for a specific charge, etc.). Similarly, satellite TV providers, broadcast TV stations, or telephone companies offering television programming over telephone lines or fiber optic cables may suitably apply the teachings of the present invention to more conveniently offer audio-visual content to their customers as per the teachings of the present invention.

It is noted here that, for ease of discussion, a DVD movie is used as an example of a user-requested VOD content in the discussion below. However, as mentioned above, it is understood that the VOD content may include non-movie audio-visual programs as well. Furthermore, the terms “cable service provider” and “cable operator” are used interchangeably herein to refer to an entity delivering audio-visual contents (which may have been generated by some other entity) via a cable television network to its cable television subscribers.

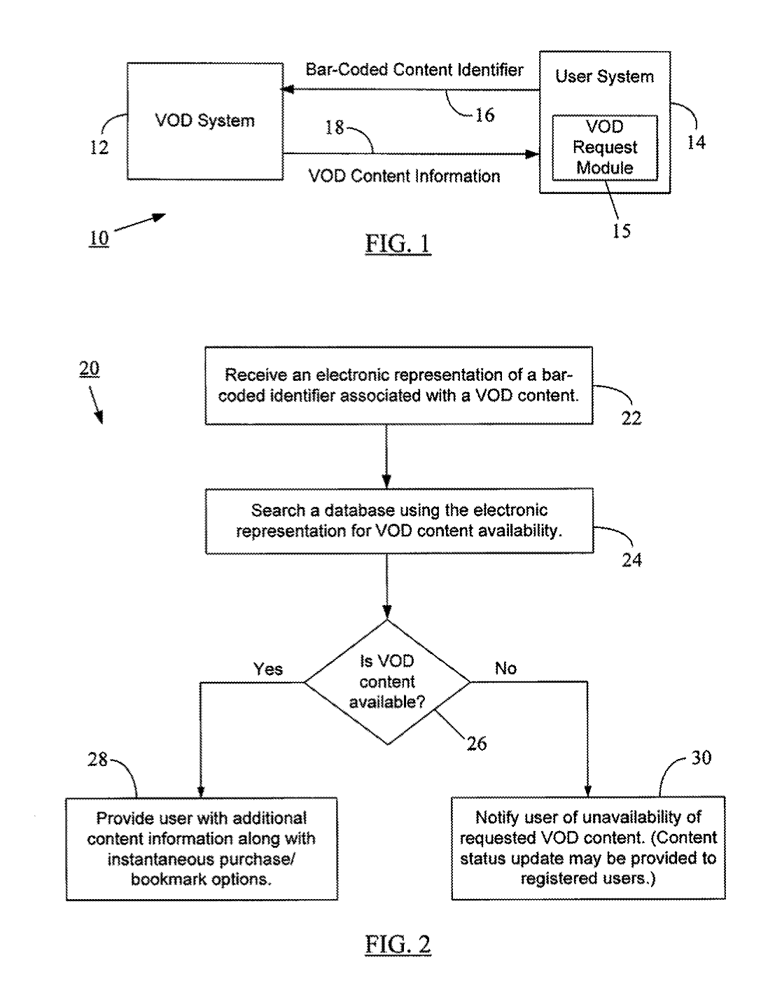

FIG. 1 is a simplified block diagram of an exemplary embodiment of a VOD distribution system 10 of the present invention. A VOD system 12 is shown to be in communication with a user device 14 running a VOD request module or software 15 according to one embodiment of the present invention. The VOD request module 15 may allow the user device 14 to scan or generate an image of a bar-coded identifier (for example, a UPC (Universal Product Code)) associated with the user-desired VOD content and send the scan or image of the bar-coded identifier to the VOD system 12. For example, the bar-coded identifier may appear on a packaging of a movie's DVD or on the DVD itself. The user may see the movie's DVD in a store and may wish to instantaneously access that movie through the user's cable provider's VOD system 12. In that case, the user may engage the user device 14 to scan the DVD's UPC number (i.e., the bar-coded content identifier associated with the VOD content (here, a movie) desired by the user) and send this UPC number to the cable operator's VOD system 12 as indicated by arrow 16 in FIG. 1. It is observed here that the user need not be aware of or need not search each VOD catalog title offered by user's cable provider to identify the movie-of-interest prior to sending the bar-coded content identifier to the VOD system 12. Upon receipt of the bar-coded identifier from the user device 14, the VOD system 12 may inform the user (as indicated by arrow 18) if the requested movie title is available for immediate delivery via cable provider's VOD service or if the title is currently unavailable for immediate viewing/purchase. In the latter case, the VOD system 12 may also provide a notification to the user device 14 in the future when the requested VOD title becomes available for immediate delivery.

The VOD request module 15 may be a software application provided by the user's cable operator and may be configured to enable the user device 14 to uniquely identify and communicate with cable operator's VOD system 12. Alternatively, the program code for the VOD request module 15 may be developed by a third party or may be an open source software that may be suitably modified for use with the cable operator's VOD system 12. The VOD request module 15 may be downloaded from a website (for example, the cable service provider's website) or may be supplied on a data storage medium (for example, a compact disc (CD) or DVD) for download on the appropriate user device 14. The functionality provided by the VOD request module 15 may be suitably implemented in software by one skilled in the art and, hence, additional design details of the VOD request module 15 are not provided herein for the sake of brevity.

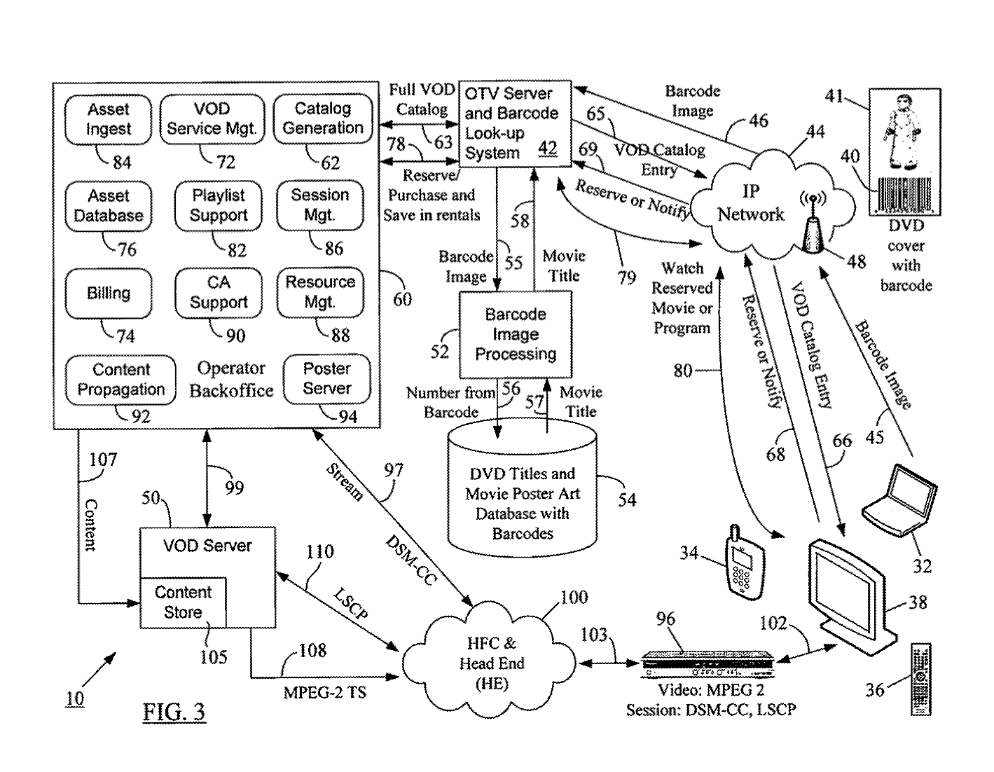

FIG. 2 is a flow chart 20 of a first exemplary embodiment of the VOD content distribution method of the present invention. For ease of discussion, the flow chart 20 of FIG. 2 is explained in conjunction with FIG. 3, which shows exemplary details of the VOD distribution system 10 illustrated in FIG. 1 according to one embodiment of the present invention. As indicated at block 22 in FIG. 2, the VOD system 12 may receive (from the user device 14) an electronic representation of a bar-coded identifier associated with a user-desired VOD content. The electronic representation may include a scan or image of just the bar-coded identifier, an image of a larger portion (for example, an entire DVD cover or movie poster) containing the bar-coded identifier, or an electronic entry of numbers constituting the bar-coded identifier.

In the embodiment where the VOD system 12 is managed, operated, or supported by a cable service provider, the user (or sender of the electronic representation of the bar-coded identifier) may be a cable subscriber. The user device 14 may include a variety of Internet Protocol (IP)-enabled devices configured to run the VOD request module 15 and equipped with an optical input device (for example, a barcode reader, a camera, etc.). Such devices may include, for example, a computing unit 32 (for example, a laptop computer, or a desktop computer), a web-enabled smart phone (or other cellular phone) 34, or a specially-configured television remote control 36 that provides bar code scanning and transmission functionality along with IP packet data reception capability. In one embodiment, the remote control 36 (or some other user device) may not have the bar code scanning functionality. In that case, the remote control 36 may be used in conjunction with a web-enabled television set 38 (for example, modern HDTVs (High Definition Television)) to allow a user to manually enter the barcode digits and send the entered number to the VOD system 12 via the Internet-connected TV 38. Similarly, when it is not convenient to scan or image the bar code, the cable subscriber may choose to manually enter the bar code number via the user device 14 (for example, using the keyboard of the laptop computer 32). It is noted here that the exemplary user devices 32, 34, etc., are shown in FIG. 3 for illustrative purpose only. It does not imply that the user has to either use all of these devices to communicate with the VOD system 12 or that the VOD system 12 communicates with only the type of user devices shown.

As mentioned before, the bar-coded content identifier for the VOD content of interest (here, a movie) may include a Universal Product Code (UPC), a 2D (two-dimensional) bar code, a 3D (three-dimensional) bar code, a bar code having the UPC embedded within the barcode, a QR (Quick Response) barcode embedded within a movie preview (or visual representation of a portion of the movie, for example, as a “coming attraction”), movie ticket or some other type of advertising collateral for the movie. In certain embodiments, the bar-coded content identifier may appear as a watermark or hologram. In the embodiment of FIG. 3, a UPC code 40 for the movie of interest is shown printed on the DVD jacket 41 of the movie. Alternatively, the UPC code 40 or other bar-coded identifier may have been printed on the data storage medium (for example, a Digital Versatile Disk or DVD) containing the movie or any other advertising material (for example, a poster, or a printed catalog of movie titles) for the movie. The bar-coded identifier may also appear embedded in online or television previews/advertisements of the movie.

As also mentioned before, the user may encounter the movie of interest at many different places such as, for example, a brick-and-mortar store, a printed movie catalog, an online movie commercial, a movie preview being shown on user's cable TV 38, etc. If the movie interests the user, the user may directly use the device 14 (which may be equipped with a digital camera, a barcode scanner, or other type of optical input device) to scan or image the UPC or other barcode (that may include the UPC embedded within the barcode) associated with the movie. As noted before, the barcode may have been placed on the DVD cover of the movie of interest, printed on movie's advertising materials or posters, embedded in the movie's commercial, etc. When the user presses a pre-designated button on the user device 14 or touches a specific area on a touch-screen of the device 14, the VOD request module 15 may configure the device 14 to scan or take an image of the barcode and transmit the barcode image to a processor 42 within the VOD system 12 via an IP (Internet Protocol) or TCP/IP (Transmission Control Protocol/Internet Protocol) network 44 as indicated by arrows 45-46 in FIG. 3. Instead of taking an image of just the barcode 40, the user may choose, for the sake of convenience, to use the device 14 to take an image of the entire DVD cover 41 (or movie poster) on which the barcode 40 appears. In that case, the entire image (containing the barcode as part thereof) may be sent to the processor 42 to identify the barcode printed thereon.

In one embodiment, the processor 42 may include an Over-the-Top Video (OTV) server and Barcode Look-up System (simply “the OTV server”) that is configured to communicate with the IP network 44 using TCP/IP-based data communication. The IP network 44 may be, for example, the Internet (including the world wide web portion of the Internet) including portions of one or more wireless networks as part thereof (as illustrated by an exemplary wireless access point 48) to receive communications from a wireless user device such as the cell phone (or smart phone) 34 or wirelessly-connected laptop computer 32. In one embodiment, the cell phone 34 may be Wireless Access Protocol (WAP)-enabled to allow IP-based communication with the IP network 44. The term “OTV” may be used to distinguish the IP-based video server 42 from the traditionally non-IP based VOD server 50 (discussed below). Thus, it is observed here that the OTV server 42 may communicate with the user device 14 (for example, the user smartphone 34 or user laptop computer 32) via the Internet to identify, reserve, and deliver user-requested VOD content over the Internet, or to notify users regarding the VOD content available for access via the VOD server 50 as discussed in more detail below.

Upon receiving the barcode scan or image, or an image of the entire DVD box cover with the barcode on it, the OTV server 42 may search a database using the received image for the availability of the user-requested movie title, as indicated at block 24 in FIG. 2. The OTV server 42 may communicate with a barcode image processing/analysis module 52 and a movie database 54. In one embodiment, the image processing module 52 and the database 54 may be a part of or may be under operational control of the OTV server system 42. The movie database 54 may associate movie-related information (for example, movie's title appearing on DVDs, images of movie's DVD box cover or poster, etc.) with movie-specific unique identifiers such as barcodes. A database mapping of all known identifiers (for example, DVD UPC numbers, QR barcodes in movie previews, etc.) associated with a specific movie title may be stored in the database 54. Furthermore, a UPC number (or other barcode identifier in numerical format) may be added to a metadata file associated with the movie title for easy reconciliation between a movie title or offering, and a UPC code received from the user device 14. Thus, in one embodiment, the database 54 may contain content-identifying information for all movie or relevant audio-visual program titles available in the market, regardless of whether all such titles are currently available through the cable operator's VOD system 12.

When the OTV server 42 sends the user-provided barcode image to the image processing/analysis module 52 (as indicated by arrow 55 in FIG. 3), the module 52 may recognize the received image and interpret the data represented by or contained within the barcode. The module 52 may then provide a numerical representation of the received barcode (as indicated by arrow 56) that may be passed as a search query to the database 54. When an image of the movie's DVD box cover or poster is received from the user, the image processing module 52 may use the received image to find a matching movie poster art or DVD image in the database 54. The search of the database 54 (using the number from the barcode or other unique identifier such as image of a DVD box cover or movie poster) may return the corresponding movie's title and/or other identifying information (for example, names of actor, director, producer, year when movie was made, songs appearing in the movie, etc.) to the OTV server 42 (as indicated by arrows 57-58). In one embodiment, the OTV server 42 may instruct the image processing module 52 to perform the database search or the server 42 itself may perform the database search using the barcode number analyzed by the image processing module 52 as a query to the database 54.

As mentioned before, instead of scanning a barcode, the user may simply enter the barcode numbers, for example, in an entry field displayed by the VOD request module 15 on a display screen (not shown) of the user device 14. When the OTV server 42 receives the barcode numbers, the OTV server may bypass the barcode analysis and may directly search the database 54 for the corresponding movie title and receive the appropriate search results as discussed earlier.

In one embodiment, the OTV server 42 may be coupled to the cable operator's back office 60 to allow the OTV server 42 to maintain a list of all VOD catalog titles offered by the cable operator for immediate delivery. To receive the current VOD catalog, the OTV server 42 may query or search a VOD catalog generation unit (or VOD catalog server) 62 in the operator back office 60 to receive the most up-to-date version of the cable operator's VOD catalog (as indicated by the arrow 63 in FIG. 3). In one embodiment, the OTV server 42 may obtain the full VOD catalog prior to receiving VOD content-related queries from users. Thus, as indicated at block 26 in FIG. 2, upon receiving the search result (for example, movie's title) from the database 54, the OTV server 42 may search the VOD catalog stored in a memory (not shown) therein to determine if the user-requested movie title (as provided in the search result from the database 54) is listed in the cable operator's VOD catalog. If the movie title matches with an entry in the VOD catalog, it may imply that the user-requested VOD content is currently available for viewing or immediate delivery by the cable operator's VOD system 12. In the case where the movie is available through the VOD system 12, the OTV server 42 notifies the user device 14 (which sent the electronic image of the movie's bar-coded identifier) of the item title and its availability using an IP network-based communication (as indicated by arrows 65-66). In one embodiment, other title-related information (for example, a brief review of the movie, user-ratings for the movie, etc.) and price for the instantaneous purchase of the requested VOD content also may be sent to the user device 14 (as indicated at block 28 in FIG. 2).

Upon receiving OTV server's 42 indication of availability of the requested movie in cable operator's VOD catalog, the VOD request module 15 may configure the user device 14 to prompt the user with options to immediately play the movie on the device 14 itself or to watch the movie later using, for example, a VOD session setup/teardown in the “My Rentals” framework offered through the cable operator's VOD service. Thus, if the user chooses to watch the movie at a later time, the user may “save” or “bookmark” the movie title in the “My Rentals” section of the VOD service by accessing the user's VOD account online (i.e., at the cable operator's website) via the user device 14. Additional options that may be presented to the user include an option to immediately purchase the movie (for delivery online via streaming video or through other means to the user's device that is in communication with the OTV server 42) or to specify a device (other than the current user device that is in communication with the OTV server 42) to which the requested VOD content should be delivered. Thus, for example, when the requested movie is available as a VOD content, the user may choose to watch it immediately on the user's laptop 32 or smartphone 34 that is in communication with the OTV server 42. Alternatively, the user may choose to watch the movie on user's television 38 instead of downloading it on user's laptop 32 or smartphone 34. In any event, the user may send user's preference (to reserve the movie, or to not reserve the movie, or to deliver it to another device, etc.) to the OTV server 42 as indicated by arrows 68-69 in FIG. 3.

If the user's choice is to purchase or watch the movie on VOD, the OTV server 42 may substantially instantaneously initiate download of the movie via the IP network 44 onto the user device 14. In that case, the OTV server 42 may first verify user's cable subscription, VOD account eligibility, and other accounting details by sending user's account ID (which may be automatically transmitted by the VOD request module 15 when the user initiates communication with the OTV server 42, or which may be assigned to the user based on the user's existing session on the OTV server 42, etc.) to a VOD service management module 72 in the operator back office 60. In one embodiment, the VOD request module 15 may request such cable subscriber account information upon its initial execution and store the user account details in the user device 14 for use when needed. The OTV server 42 may also transmit user's VOD purchase request to a billing module 74 to generate appropriate billing record for the user's VOD transaction. Upon confirming or verifying user's eligibility to purchase the VOD content, the OTV server 42 may access a VOD asset database 76 containing cable operator's VOD catalog titles in their entireties to retrieve the user-selected movie therefrom. The OTV server 42 may then stream the movie to the user device 14 for the user to watch it immediately, or may allow the user to download the movie from the asset database 76 for viewing later. This VOD content access and delivery process is illustrated by arrows 78-80 in FIG. 3.

Referring again to FIG. 2, in case where the user-requested movie title doesn't match with any entry in the cable operator's full VOD catalog, the OTV server 42 may return the movie title along with a non-match indicator to the user's device 14 via the IP network 44 (as indicated by blocks 26 and 30 in FIG. 2). In one embodiment, the intimation of unavailability of the requested VOD content may also include an option for the user to register user's e-mail account or cell phone number to receive a notification from the OTV server 42 when the desired VOD content becomes available in the future for immediate delivery. If the user wishes to register for such notification service (as indicated by arrows 68-69 in FIG. 3), the OTV server 42 may access a playlist support module 82 with the help of the VOD service management module 72 to register the user for updates regarding the requested (but presently unavailable) movie title. The playlist support module 82 may store information about the user's requested movie title and may search the asset database 76 for a title match whenever new content is added to it through an asset ingest module 84. In the case where a newly-added title matches user's reservation, each registered user may receive a notification from the OTV server 42 indicating availability of the reserved content on VOD. The notification may be in the form of an e-mail to the user's registered e-mail address, or an SMS (Short Messaging Service) message to the user's registered cell phone number, or some other similar indicator.

In one embodiment, the unavailability intimation from the OTV server 42 may also include an option for the user to reserve the VOD content as soon as it becomes available in future. In that case, when the content becomes available, it may be immediately delivered to the user without additional inputs from or administrative burden on the user. In another embodiment, the OTV server 42 may submit user's reservation request (indicated by arrows 68-69 and 78 in FIG. 3) to a recommendation engine (not shown) in the playlist support module 82 to send recommendations of other (currently-available) movies the user may be interested in based on the user's reservation. Thus, the OTV server 42 may give an option to the user to select another movie of interest for immediate delivery through the VOD system 12 while the user waits to receive the originally requested movie. If the user chooses to access such a recommended movie (or movies), the movie's title information (or other unique identifier such as DVD picture, image of the movie's poster, etc.) may be transmitted along with the user's ID (or other cable subscriber account information) to the VOD service management module 72 and billing module 74. As before, upon confirming or verifying user's eligibility (for example, whether the user is underage, or if the user account is in default, etc.) to purchase the recommended movie, the OTV server 42 may access the VOD asset database 76 to retrieve the movie content therefrom and stream or download it to the user's device 14 via the IP network 44.

In another embodiment, when the user-requested VOD content is unavailable in the VOD system 12, if the user's cable operator is able to access a VOD catalog of other cable operator (or audio-visual content provider), then the VOD service management module 72 may perform a check with the other service provider's system before responding to the user's request. Thus, in case the requested movie title is available with such other service provider but unavailable in the VOD system 12, the VOD service management module 72 may at least temporarily “reserve” it on behalf of the user and let the user know of the availability of the title through the OTV server 42. Depending on the pricing arrangement between the cable operators, there may be an additional charge for this “convenience” feature. In exchange, the user receives an access to the desired VOD content immediately, without having to wait for it to become available in the user's current cable operator's VOD system 12. However, if the user decides not to purchase or download the VOD content through such a third-party arrangement, the OTV server 42 may inform the user's decision to the VOD service management module 72, which may, in turn, “release” its temporary reservation of the title by appropriately notifying the other service provider's system.

Thus, according to the teachings of the present invention, a cable subscriber may access a movie of interest (or other audio-visual content of interest) substantially instantaneously over the Internet via the cable operator's VOD service, without going through tedious search of the VOD catalog through the menu on the set-top box or on cable operator's website. As mentioned before, the cable subscriber may not even need to know whether the requested movie title is available in the cable operator's VOD catalog. A simple scan of the movie's bar-coded identifier is all that may be needed from the cable subscriber to immediately access the movie's content on VOD at the subscriber's choice of display device. The IP-based delivery of VOD content affords the user mobility and flexibility in ordering, downloading, and viewing the requested VOD content at a location that may not be where the user's cable television is physically connected to the cable operator's network.

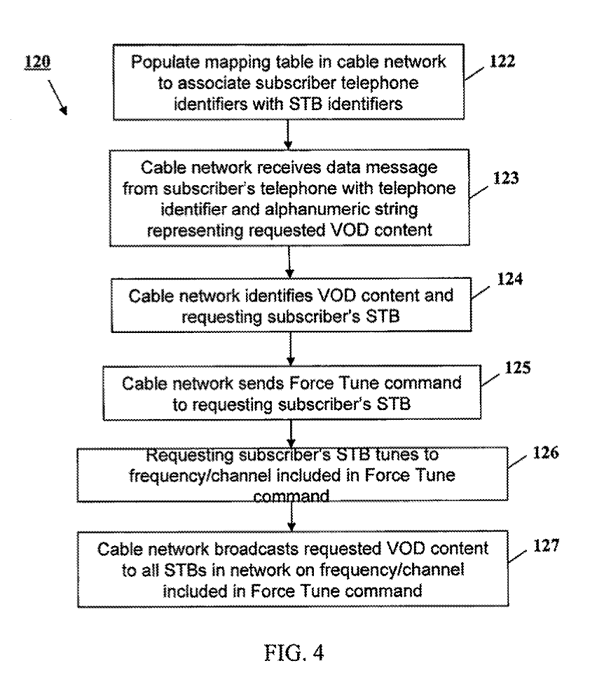

Referring to FIG. 4, there is illustrated a flow chart 120 of a second exemplary embodiment of the VOD content distribution method of the present invention. In this embodiment, the invention provides flexibility in certain non-interactive or “one-way” cable systems (for example, satellite cable service, or cable service in certain foreign countries) that do not otherwise allow interactive request and delivery of VOD content. Instead of using an over-the-top IP-based solution, the subscriber may order the on-demand content by telephone. At step 122, the cable system operator populates a mapping table or lookup table that associates identifiers of subscriber telephones with identifiers of subscriber Set-Top-Boxes (STBs). At step 123, the cable system receives a data message such as, for example, an SMS text message or e-mail from the subscriber's telephone with a telephone identifier and a number or other alphanumeric string representing requested VOD content. In an exemplary scenario, the cable system operator may supply the subscriber with a printed catalog containing reference numbers for all of the VOD content in the operator's content library. The subscriber may enter the reference number manually through his telephone keypad. Alternatively, the catalog may also print a computer-readable bar code (one dimensional or two dimensional) next to each listing in the catalog, and the subscriber can enter it by taking an image with his telephone.

At step 124, the cable system identifies the requested VOD content and identifies the requesting subscriber's STB from the identifier of the subscriber's telephone. At step 125, the cable system sends a Force Tune command to the requesting subscriber's STB. The Force Tune command includes an STB identifier for the requesting subscriber's STB and a frequency/channel. At step 126, the identified STB responds to the command by tuning to the frequency/channel included in the command. At step 127, the cable system broadcasts the requested VOD content to all STBs in the network on the frequency/channel included in the Force Tune command. However, only the STB that matches the STB identifier in the command responds to the Force Tune command. This process provides operators having one-way systems with a way to enable customers to watch VOD content without STB interactivity.

Referring again to FIG. 3, the operator back office 60 may be electrically coupled to the IP-based OTV server 42 and the traditional VOD sever 50, and may serve as an interface unit between these two servers 42, 50. In addition to the modules discussed hereinbefore, the operator back office 60 may also include additional modules such as, for example, a session management module 86, a resource management module 88, a conditional access (CA) support module 90, a content propagation module 92, and a poster server 94. It is noted here that, in certain embodiments, functionalities of many of the modules shown in FIG. 3 as part of the cable operator's back office 60 may be combined, thereby reducing the number of modules in the back office 60. Alternatively, additional modules (not shown in FIG. 3) also may be part of the back office 60. The session management module 86 may interact with the resource management module 88 for allocating and controlling communications resources (for example, sending a VOD session establishment signal to the VOD server 50, establishing cable channel frequency for VOD content delivery through the VOD server 50, or monitoring duration of Internet download of a VOD content through the OTV server 42 or user's communication with the server 42, etc.) for content delivery authorized by the VOD service management module 72. The CA support module 90 may provide key to authorized users to decrypt the encrypted VOD content that may be delivered by the VOD server 50. The content propagation module 92 may provide radio frequency (RF) transmission of VOD content to the VOD server 50. The poster server 94, on the other hand, may provide images of movie posters or DVD covers to build-up the database 54. The poster server 94 may also interface with the asset ingest module 84 to establish appropriate entries in the database 54 for the VOD titles received, handled, or managed by the cable operator as part of its VOD catalog.

It is observed here that, during the user's interaction with the OTV server 42, if the user has indicated to watch the VOD content on the television 38 or other Customer Premises Equipment (CPE) (such as a computer (not shown) or a set-top box 96 that is capable of receiving VOD content through RF signals and convert the signals to signals that are compatible with display devices such as analog televisions or computer monitors), then the OTV server 42 may notify this user choice to VOD service management module 72, which, in turn, may engage the content propagation module 92 to either directly stream the VOD content to the user's CPE (for example, the set-top box 96, the television 38, etc.) using, for example, the DSM-CC (ISO MPEG-2 Digital Storage Media Command and Control) protocol (as indicated by arrow 97 in FIG. 3) or communicate with the VOD server 50 (as indicated by arrow 99 in FIG. 3) to facilitate transmission of the requested VOD content to the user's television 38 (or other CPE) via the set-top box 96. The VOD server 50 may be coupled to a cable broadband network 100, which can be implemented by a hybrid fiber-coaxial (HFC) broadband network. For ease of illustration, the cable network 100 is shown to also include a cable headend (HE) (for example, a regional headend). However, in certain embodiments, the headend may exist separately from the underlying cable network. The HFC network 100 can be used to couple a cable subscriber's set-top boxes 96 (which may be further coupled to cable subscriber's televisions 38 as indicated by an arrow 102) to the VOD server 50 as indicated by an arrow 103. The content propagation module 92 may deliver or store the requested VOD content into a content storage or memory 105 in the VOD server 50 as indicated by an arrow 107. In one embodiment, the VOD server 50 may then deliver or transmit the stored VOD content to the set-top box 96 (and, hence, to the television 38) via an MPEG-2 Transport Stream (TS) using a Quadrature Amplitude Modulation (QAM)-based protocol such as, for example, the Lightweight Streaming Control Protocol (LSCP), as indicated by arrows 108, 110 in FIG. 3. The set-top box may receive the MPEG-2 VOD content either under a DSM-CC session or an LSCP session, and convert the received content for user's viewing on the television 38.

It is seen from bi-directional arrows 97, 99, 102-103, and 110 in FIG. 3 that the user may still be able to request and receive the VOD content in the traditional manner using the VOD catalog on the set-top box 96 and by clicking through the choices (for example, using the remote control 36) displayed on the television 38.

In one embodiment, the VOD server 50 may support IP-based content delivery, either itself or in combination with other system (not shown). In that case, the cable operator's VOD system 12 may include a single server implementing the functionalities of the ON server 42 and the VOD server 50. Alternatively, the IP-supporting VOD server 50 itself may integrate functionality of the OTV server 42 to provide IP-based and non-IP based VOD content delivery discussed hereinbefore.

In the embodiment of FIG. 3, each of the servers 42, 50 (and any other processing device) may also include a respective memory (not shown) to store the program code to carry out the relevant steps depicted in FIG. 2. The server's processor(s) (not shown) may invoke/execute that program code to implement the desired functionality. Thus, the servers 42, 50 (or any other processing device) may be configured (in hardware, via software, or both) to carry out the VOD content search and delivery functionalities referred to in the flow chart in FIG. 2. For ease of illustration, such server architectural details are not shown in FIG. 3. It is noted, however, that the execution of the program code (for example, by a processor in a server) may cause the server 42, 50 to perform a relevant function, process step, or part of a process step in FIG. 2 to implement the desired task. Thus, although the servers 42, 50 (or other processing devices) may be referred to herein as “performing,” “accomplishing,” or “carrying out” a function or process, it is evident to one skilled in the art that such performance may be technically accomplished in hardware and/or software as desired. The servers 42, 50 may include a processor(s) such as, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Furthermore, the memories (for example, the content store 105) in the servers 42, 50 may include a computer-readable data storage medium. Examples of such computer-readable storage media include a Read Only Memory (ROM), a Random Access Memory (RAM), a digital register, a cache memory, semiconductor memory devices, magnetic media such as internal hard disks, magnetic tapes and removable disks, magneto-optical media, and optical media such as CD-ROM disks and Digital Versatile Disks (DVDs). Thus, the methods or flow charts provided herein may be implemented in a computer program, software, or firmware incorporated in a computer-readable storage medium (not shown) for execution by a general purpose computer or a server (such as the servers 42, 50).

The foregoing describes a system and method of facilitating VOD content search and distribution. As described hereinbefore, a user scans a bar-coded identifier placed on a movie package (for example, a DVD or Blu-ray disc cover) or a Quick Response (QR) barcode that is placed in a movie preview, movie ticket, or some other type of advertising collateral for a movie or other audio-visual program of interest. When the user scans the identifier, the software on the user's device recognizes the identifier, and queries the cable service provider's VOD system as to the availability of the requested movie/program title. If the title is an offering within the VOD system, the VOD system allows the user to substantially instantaneously purchase and/or bookmark the movie/program title via user's mobile device. In the case where the title is not available on the VOD system, the VOD system can send a notification to the user when the title is available for access on the VOD system. In view of the bar code scan-based search and retrieval of VOD content, the present invention provides a significantly effortless means to request desired VOD titles—even when a user is unaware of the titles available in a cable service provider's VOD catalog. Furthermore, the IP network-based communication affords users substantially universal and instantaneous access to the desired VOD content without restricting the user's viewing option to a fixed television set. Because of availability of VOD content at many more devices than just a television set, user mobility is greatly enhanced without sacrificing the user's ability to order and view the desired VOD content.

As mentioned before, the IP-based submission of user queries and transmission of system responses/notifications (including the delivery of the user-requested VOD content through the Internet) allows the teachings of the present invention to be implemented beyond “traditional” cable provider networks. Thus, such content providers as, for example, satellite and broadcast television providers, online DVD movie rental/download services offering streaming video/movie rentals on subscription-basis, or telephone companies offering television programming over telephone lines or fiber optic cables, can suitably implement teachings of the present invention to more conveniently offer audio-visual content to their customers “on demand” and with greater flexibility.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of offering video-on-demand (VOD) content, the method comprising the steps of:
using a processor, receiving an electronic representation of a bar-coded identifier associated with the VOD content;
using the processor, searching a database using the electronic representation to determine availability of the VOD content for immediate delivery; and
using the processor, providing a sender of the electronic representation with a first option to substantially instantaneously access the VOD content when the VOD content is determined to be available for immediate delivery.

2. The method of claim 1, wherein the sender is a prospective viewer of the VOD content.

3. The method of claim 1, wherein the electronic representation is one of:
a scanned version of the bar-coded identifier;
an image of the bar-coded identifier; and
an alpha-numeric data entry corresponding to the bar-coded identifier.

4. The method of claim 1, wherein the bar-coded identifier is one of:
a Universal Product Code (UPC) bar code;
a two-dimensional (2D) bar code;
a three-dimensional (3D) bar code; and
a Quick Response (QR) bar code.

5. The method of claim 1, wherein the bar-coded identifier is one of:
an embedded feature in a visual representation of a portion of the VOD content;
a first printed matter on a package containing a tangible data storage medium having the VOD content stored therein;
a second printed matter on the tangible data storage medium; and
a third printed matter on an advertising material for the VOD content.

6. The method of claim 1, wherein providing the sender with the first option includes at least one of:
providing the sender with a second option to immediately watch the VOD content;
providing the sender with a third option to watch the VOD content at a later time;
providing the sender with a fourth option to immediately purchase the VOD content; and
providing the sender with a fifth option to specify a device to which the VOD content is to be delivered.

7. The method of claim 1, further comprising:
using the processor, providing the sender with at least one of the following when the VOD content is determined to be unavailable for immediate delivery:
an intimation of unavailability of the VOD content;
a second option to register to receive a notification when the VOD content becomes available for immediate delivery;
the notification if the sender is registered to receive the notification; and
a third option to reserve the VOD content as soon as the VOD content becomes available in future.

8. The method of claim 1, wherein receiving the electronic representation includes receiving the electronic representation via an Internet Protocol (IP) network.

9. The method of claim 1, wherein providing the sender with the first option includes providing the first option to the sender via an Internet Protocol (IP) network.

10. The method of claim 9, further comprising, using the processor to deliver the VOD content to the sender via the IP network.

11. The method of claim 1, further comprising delivering the VOD content to the sender via a cable broadband network.

12. A method of offering video-on-demand (VOD) content to a cable subscriber, wherein the VOD content is offered by a cable provider, the method comprising:
the cable provider allowing the cable subscriber to send an electronic representation of a bar-coded identifier associated with the VOD content to a processor;
the cable provider configuring the processor to use the electronic representation received thereby to determine availability of the VOD content for immediate delivery; and
using the processor, the cable provider providing the cable subscriber with an option to substantially instantaneously watch the VOD content when the VOD content is determined to be available for immediate delivery.

13. The method of claim 12, wherein the electronic representation is one of:
a scanned version of the bar-coded identifier;
an image of the bar-coded identifier; and
an alpha-numeric data entry corresponding to the bar-coded identifier.

14. The method of claim 12, wherein the bar-coded identifier is one of:
a Quick Response (QR) bar code embedded in a visual representation of a portion of the VOD content;
a Universal Product Code (UPC) bar code; and
a bar code printed on one of the following:
a package containing a tangible data storage medium having the VOD content stored therein,
the tangible data storage medium, and
an advertising material for the VOD content.

15. The method of claim 12, further comprising:
the cable provider configuring the processor to provide to the cable subscriber an intimation of unavailability of the VOD content when the VOD content is determined to be unavailable for immediate delivery and to send a notification to the cable subscriber when the VOD content becomes available for immediate delivery.

16. The method of claim 12, wherein the cable provider allows the cable subscriber to send the electronic representation via an Internet Protocol (IP) network and the cable provider provides the option to the cable subscriber via the IP network, wherein the cable provider delivers the VOD content to the cable subscriber via at least one of:
the IP network; and
a cable broadband network.

17. A system for offering requested video-on-demand (VOD) content, the system comprising:
a first database having stored therein a plurality of data entries along with a corresponding plurality of bar code identifications, wherein each data entry is associated with a corresponding VOD content;
a VOD catalog server having stored therein information as to availability of the requested VOD content for immediate delivery; and
a first processor coupled to the first database and the VOD catalog server, wherein the first processor is configured to:
receive, via an Internet Protocol (IP) network, an electronic representation of a bar-coded identifier associated with the requested VOD content,
search the first database using the electronic representation to identify therein a data entry associated with the requested VOD content,
access the VOD catalog server using the identified data entry to determine availability of the requested VOD content for immediate delivery, and
provide, via the IP network, an option to a sender of the electronic representation to substantially instantaneously access the requested VOD content when the requested VOD content is determined to be available for immediate delivery.

18. The system of claim 17, further comprising:
a second database having the requested VOD content stored therein;
wherein the first processor is configured to access the second database to retrieve the requested VOD content therefrom and deliver the requested VOD content to the sender via the IP network.

19. The system of claim 17, wherein the first processor is configured to receive an instruction from the sender to deliver the requested VOD content via a cable broadband network, wherein the system further comprises:
an interface unit; and
a second processor;
wherein the interface unit is electrically coupled to the first processor and the second processor, wherein the first processor is further configured to send the instruction from the sender to the interface unit and the interface unit is configured to instruct the second processor to deliver the requested VOD content via the cable network, and wherein the second processor is configured to deliver the requested VOD content via the cable network as instructed by the interface unit.

20. The system of claim 17, wherein, upon failing to identify the data entry associated with the requested VOD content, the first processor is configured to provide the sender with at least one of:
an intimation of unavailability of the requested VOD content;
a notification when the requested VOD content becomes available for immediate delivery; and
an opportunity to reserve the requested VOD content as soon as the requested VOD content becomes available in future.

21. A method of providing requested video-on-demand (VOD) content to a cable subscriber in a cable television system that does not otherwise provide interactive request and delivery of VOD content, the method comprising the steps of:
configuring a mapping table that associates an identifier of the cable subscriber's telephone with a set-top-box (STB) identifier of the cable subscriber's STB;
receiving by a processor in the cable television system, a data message sent from the cable subscriber's telephone, the data message including the identifier of the cable subscriber's telephone and a number or alphanumeric string representing the requested VOD content;
identifying by the processor, the STB identifier of the cable subscriber's STB from the identifier of the cable subscriber's telephone;
sending by the processor, a Force Tune command to the cable subscriber's STB, the Force Tune command including the STB identifier of the cable subscriber's STB and a frequency/channel, wherein the Force Tune command forces only the cable subscriber's STB to tune to the frequency/channel provided in the command; and
broadcasting the requested VOD content on the frequency/channel provided in the command to all STBs in the cable television system, wherein only the cable subscriber's STB is forced to tune to the frequency/channel on which the requested VOD content is broadcast.
